(19) United States
(12) Patent Application Publication
(10) Pub. No.: US 2008/0191169 A1
(43) Pub. Date: Aug. 14, 2008

(54) Optical Brightening of Substrates for Ink Jet Printing

(75) Inventors: Peter Rohringer, Schonenbuch (CH); Robert Hochberg, Merzhausen (DE); Oliver Becherer, Schworstadt (DE); Stéphane Biry, Village-Neuf (FR)

Correspondence Address: JoAnn Villamizar;Ciba Corporation/Patent Department, 540 White Plains Road, P.O. Box 2005, Tarrytown, NY, 10591, US

(73) Assignee: CIBA SPECIALTY CHEMICALS HOLDING INC., Basel (CH)

(21) Appl. No.: 11/579,011

(22) PCT Filed: Apr. 25, 2005
(86) PCT No.: PCT/EP05/51827

§ 371 Date: Oct. 30, 2006

(30) Foreign Application Priority Data
May 3, 2004 (EP) 04101882.1

(51) Int. Cl. C09K 11/06

(52) U.S. Cl. 252/301.25

(57) ABSTRACT

The invention relates to a composition for optical brightening of substrates suitable for ink jet printing, comprising a) a fluorescent whitening agent of the formula (1): wherein X₁, X₂, X₃ and X₄ each, independent of the other, represent —NR₁ R₂ or —OR₃, wherein R, and R₂ are, independently of each other, hydrogen, cyano, a C,-C4alkyl group, which is unsubstituted or substituted by one or two of the following residues selected from the group consisting of C,-C₄alkoxy, hydroxy, carboxyl or a salt thereof (—CO2M), cyano, carbonamido, thiol, guanidine, substituted or unsubstituted phenyl, unsubstituted or C.-C₄alkyl-substituted C₅C8cycloalkyl, halogen, a heterocycle and a sulphonic acid residue and wherein the carbon chain of an alkyl group having two, three or four carbon atoms can be interrupted by oxygen, or, alternatively, a C5-C7cycloalkyl group or R, and R₂, together with the nitrogen atom linking them, complete a 5- or 6-membered heterocyclic ring; R₃ represents C,-C₄represents H, Na, Li, K, Ca, Mg, ammonium, or ammonium that is mono-, di-, tri- or tetrasubstituted by C1-C4alkyl and/or C₂-C₄hydroxyalkyl or mixtures of fluorescent whitening agents of formula (1); b) a catatonic polymer; c) water and, optionally least one pigment and/or at least one further auxiliary, methods of use of the composition and substrates that have been treated therewith.

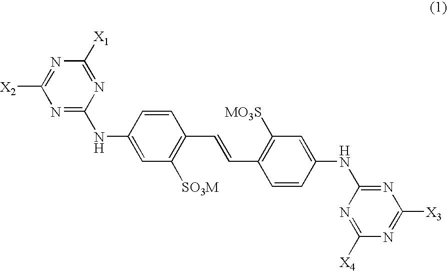

The present invention relates to a composition suitable for the optical brightening of substrates suitable for ink jet printing.

In recent years, the ink jet recording method has rapidly come into wide use in the field of printing because of advantages such as low cost, relatively high speed, low noise and easy production of multicolour images on substrates such as paper and foils.

However, for example, plain papers used for normal photographic printing are very poor in ink absorption and, consequently, when used as ink jet substrates, inks remain for a considerable period of time on the paper surface and become subject to smearing and diffusing. Dyes generally used for ink jet printing belong either to the class of water-soluble anionic direct dyes or disperse dyes, which are anionically dispersed. In order for these dyes to be fixed to the substrates, thus resulting in high resolution and good ink absorption, such substrates are normally treated with cationic polymers, which act as fixing agents for the anionic dye formulations.

Conventional fluorescent whitening agents (FWA's), which are generally derivatives of 4,4′-bis(triazinylaminostilbene)-2,2′-disulphonic acid, wherein the triazine rings carry anilino- or their mono- or disulphonic acid groups as substituents, exhibit a rather poor degree of whitening efficacy in the presence of such cationic polymers and, furthermore, whitened substrates result in poor printability due to a partial neutralization of the effect of the polymers in the presence of these anionic FWA's.

One attempt to overcome this problem has been disclosed in U.S. Pat. No. 4,620,197 and employs, instead of the conventional anionic FWA's, cationic FWA's. However such compounds are, in principle, less readily available and, consequently, of higher price than anionic analogues or those which are commercially available are unsuited for whitening of substrates such as paper and foils.

Combinations of FWA's derived from 4,4′-bis(triazinylaminostilbene)-2,2′-disulphonic acid and pigments, useful as fillers for paper pulps and coatings, have been disclosed in GB 2,284,829. However, in this case preferably conventional FWA's containing aniline substituents are incorporated into water-insoluble urea-formaldehyde resins, thus resulting in fluorescent pigments.

A process for increasing the whiteness of lignin-containing pulps, comprising adding conventional FWA's to the pulp during pulp manufacture has been disclosed in EP 899,373, whereby the negative effect of the addition of cationic starch, optionally present as an additive, is not considered or mentioned.

Surprisingly, it has now been found that by the use of particular FWA's derived from 4,4′-bis(triazinylaminostilbene)-2,2′-disulphonic acid, but lacking the conventional anilino or aniline sulphonic acid substituents, excellent degrees of whiteness may be attained, despite the presence of cationic polymers, resulting in whitened substrates exhibiting excellent ink jet recording properties.

Consequently, the invention relates to a composition for optical brightening of substrates suitable for ink jet printing, comprising

a) a fluorescent whitening agent of the formula

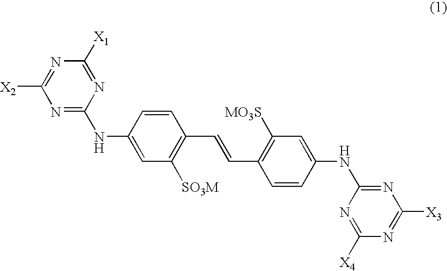

wherein

X₁, X₂, X₃ and X₄ each, independent of the other, represent —NR₁R₂ or —OR₃, wherein

R₁ and R₂ are, independently of each other,
hydrogen, cyano, a C₁-C₄alkyl group, which is unsubstituted or substituted by one or two of the following residues selected from the group consisting of C₁-C₄alkoxy, hydroxy, carboxyl or a salt thereof (—CO₂M), cyano, carbonamido, thiol, guanidine, substituted or unsubstituted phenyl, unsubstituted or C₁-C₄alkyl-substituted C₅-C₈cycloalkyl, halogen, a heterocycle and a sulphonic acid residue, and wherein the carbon chain of an alkyl group having two, three or four carbon atoms can be interrupted by oxygen,
or, alternatively, a C₅-C₇cycloalkyl group or
R₁ and R₂, together with the nitrogen atom linking them, complete a 5- or 6-membered heterocyclic ring;

R₃ represents C₁-C₄alkyl and
M represents H, Na, Li, K, Ca, Mg, ammonium, or ammonium that is mono-, di-, tri- or tetrasubstituted by C₁-C₄alkyl and/or C₂-C₄hydroxyalkyl or mixtures of fluorescent whitening agents of formula (1);

b) a cationic polymer;

c) water and, optionally,

d) at least one pigment and/or at least one further auxiliary.

Preferably, in the compound of formula (1), X₁, X₂, X₃ and X₄ each independently, represent —NH₂, —NHCN, —NHC₁-C₄alkyl, —NHC₁-C₄cyanoalkyl, —N(C₁-C₄alkyl)₂, —NHC₂-C₄hydroxyalkyl, —N(C₂-C₄hydroxyalkyl)₂, —N(C₁-C₄alkyl)(C₂-C₄ hydroxyalkyl), —NH(C₂-C₄alkylene-C₁-C₄alkoxy), —N(C₂-C₄alkylene-C₁-C₄alkoxy)₂, —NHC₁-C₄ alkylphenyl, tetrahydrofurfurylamino, morpholino, piperidino, pyrrolidino or cyclohexylamino or an —NHC₁-C₄alkyl or, —N(C₁-C₄alkyl)₂ residue in which the alkyl groups are substituted by one or two carboxyl, carboxylate, carbonamido and/or hydroxyl groups, —OC₁-C₄alkyl or mixtures of compounds of formula (1).

Especially preferred, are compounds of formula (1), in which

X₁ and X₃ each, independently, represent —NH₂, —NHCH₂CH₂OH, —N(CH₂CH₂OH)₂ or a morpholino residue,

X₂ and X₄ each, independently, represent —NR₁R₂, wherein each R₁ and R₂ independently represent hydrogen, cyano, a methyl or an ethyl group, which is unsubstituted or substituted by one residue selected from the group consisting of, hydroxy, methoxy, carboxyl or a salt thereof (—CO₂M) or R₁ and R₂ together with the nitrogen atom complete a morpholino ring and

M represents hydrogen, sodium or ammonium or mixtures of the compounds of formula (1).

Most especially preferred compounds of formula (1) are those in which X₁ and X₃ both represent —NH₂, X₂ and X₄ both represent —NR₁R₂, wherein R₁ represents hydrogen, methyl, ethyl, 2-hydroxyethyl, —CH₂CO₂M, —CH₂CH₂CO₂M or 2-methoxyethyl, R₂ represents hydrogen, methyl or 2-hydroxyethyl or X₂ and X₄ both represent a morpholino residue and M is sodium or ammonium in addition to those compounds of formula (1) in which X₁ and X₃ both represent —NHCN, —NHCH₂CH₂OH or —N(CH₂CH₂OH)₂, X₂ and X₄ both represent —NHCH₂CH₂OH, —N(CH₂CH₂OH)₂ or a morpholino residue and M is hydrogen or sodium.

Most especially preferred mixtures of compounds of formula (1) comprise asymmetric compounds in which X₁ and X₃ both represent —NH₂, X₂ is a morpholino residue, X₄ is —NHCH₂CH₂OCH₃, —NHCH₂CH₂OH, —N(CH₂CH₂OH)₂ or —NHCH₂CO₂M and M is sodium, together with the two corresponding symmetrically substituted derivatives, i.e. the corresponding compounds of formula (1) in which X₂ and X₄ are identical.

The compounds of formula (1) are known compounds or may be obtained by known procedures.

The cationic polymer present as component b) of the composition is preferably selected from the group consisting of cationic starch, quaternized or unquaternized polyvinyl amines, polyallyl amines and poly-ethylene imines, dicyandiamide condensates, polyamide-polyamine resins and polyamide-epichlorohydrin resins, whereby cationic starch and, most especially, poly-DADMAC (diallyl dimethyl ammonium chloride) are particularly preferred.

Preferably pigments present in the composition as fillers are inorganic pigments and these may, for example, be selected from the group comprising natural or synthetic silica, clay, natural or precipitated calcium carbonate, calcium sulphite, pyrophilite, kaolin, titanium oxide, aluminium hydroxide, magnesium oxide, barium sulphate and talc, as well as mixtures thereof. Fillers may be added to improve certain properties to the substrate, such as smoothness, increased density or weight, decreased porosity and increased opacity.

Furthermore, the composition may contain, as a further auxiliary, binders, agents for improving rheology and printability, fixing agents, wet-strength agents, antifoams and/or biocides. Examples of binders are polyvinyl alcohols, polyvinyl acetate, acrylic ester/styrene co-polymers, carboxylated styrene/butadiene co-polymers, polyvinyl pyrrolidone, oxidized starch, carboxymethyl cellulose and other water-soluble cellulose derivatives, whilst, for example, polyacrylamides and co-polymers thereof may serve to improve rheology and printability.

The composition according to the invention may be applied to the substrate by various methods. For example, the fluorescent whitening agent and cationic polymer may be applied as aqueous liquor by means of a size press or film press.

Thus, a further aspect of the invention is a size press or film press liquor composition, useful for the optical brightening of substrates suitable for ink jet printing, comprising
a₁) 0.001 to 1%, preferably 0.1 to 0.5%, by weight of the fluorescent whitening agent of formula (1), according to claim 1, or mixtures thereof;
b₁) 1 to 20%, preferably 2 to 15% and most preferably 7 to 12% by weight of one or more cationic polymer;
c₁) 0 to 10% of pigment and/or further auxiliaries and
d₁) water to 100%,
   in addition to method of use of the composition for the production of optically whitened substrates, in a size press or film press application, such as foils or, in particular, papers, suitable for ink jet printing and the substrate obtained thereby.

Alternatively, the composition may be applied to the substrate by coating using any type of coating equipment such as a blade coater, roll coater etc., such that a further aspect of the invention is a composition for the optical brightening of substrates suitable for ink jet printing by coating the substrate with a coating colour having a solids content comprising
a₂) 100 parts by weight of one or more inorganic pigment;
b₂) 0.01 to 1.2, preferably 0.1 to 0.8 parts by weight, based on the total weight of the pigment a₂), of the fluorescent whitening agent of formula (1), according to claim 1, or mixtures thereof;
c₂) 0.1 to 10 parts by weight, based on the total weight of the pigment a₂), of one or more cationic polymer, in particular, poly-DADMAC, quaternized or unquaternized polyvinyl amines, polyallyl amines, polyamide amines and poly-ethylene imines and
d₂) 0 to 10 parts by weight, based on the total weight of the pigment a₂), of one or more auxiliary.

The coating colour is applied to the substrate as an aqueous composition containing 5 to 70% by weight, preferably 10 to 60% by weight, of the above solid composition and 95 to 30% by weight, preferably 90 to 40% by weight, of water.

Consequently, the invention, in addition, relates to a method for the production of optically whitened substrates such as foils or, in particular, papers, suitable for ink jet printing, by coating and the substrate obtained thereby.

The following Examples illustrate the invention, without intending to be restrictive in nature; parts and percentages are by weight, unless otherwise indicated.

### EXAMPLES

The following Table 1 summarizes the fluorescent whitening agents (FWA's) of formula (1) utilized for the size press and/or coating applications.

TABLE 1

| | |
|---|---|
| | (1) |
| 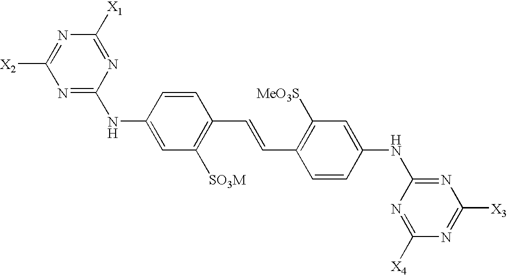 | |

| FWA | X₁ | X₂ | X₃ | X₄ | M |
|---|---|---|---|---|---|
| (101) | —NH₂ | 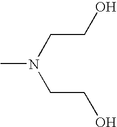 | —NH₂ | 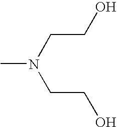 | Na |
| (102) | —NH₂ | 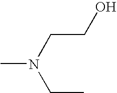 | —NH₂ | 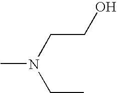 | Na |
| (103) | —NH₂ | 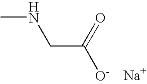 | —NH₂ | 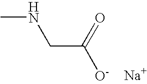 | Na |
| (104) | —NH₂ | 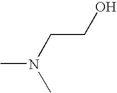 | —NH₂ | 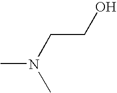 | Na |
| (105) | —NH₂ | 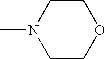 | —NH₂ | 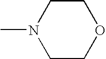 | Na |
| (106) | —NH₂ | 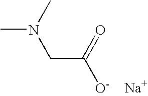 | —NH₂ | 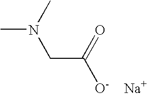 | Na |
| (107) | —NH₂ | 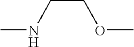 | —NH₂ | 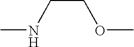 | Na |
| (108) | 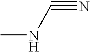 | 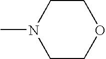 | 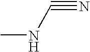 | 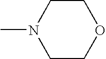 | Na |
| (109) | 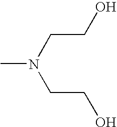 | 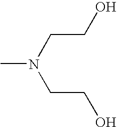 | 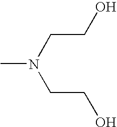 | 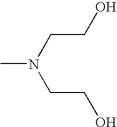 | Na |
| (110) | 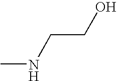 | 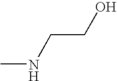 | 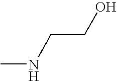 | 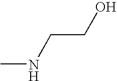 | Na |
| (111) | 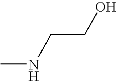 | 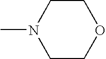 | 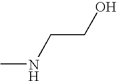 | 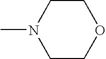 | Na |
| (112) | —NH₂ | —NH₂ | —NH₂ | —NH₂ | NH₄ |
| (113) | —NH₂ | 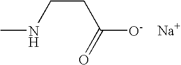 | —NH₂ | 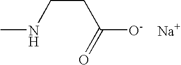 | Na |
| (114) | —NH₂ | 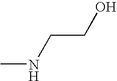 | —NH₂ | 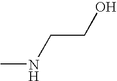 | Na |
| (115) | —NH₂ | 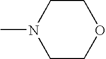 | —NH₂ | 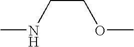 | Na |
| (116) | —NH₂ | 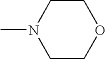 | —NH₂ | 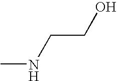 | Na |
| (117) | —NH₂ | 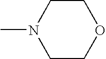 | —NH₂ | 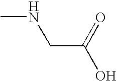 | Na |

The above compounds (101)-(1 17) are known compounds or can be prepared by known procedures.

Size Press/Metering Size Press Application

To 100 g of an aqueous solution containing 8.0 g of cationic modified potato starch with a degree of substitution of 0.025, 0.1 g of a hydrogenated starch hydrolysate (Polysorbate) and 1.8 g of a water-soluble acrylic co-polymer, 0.22 g of the appropriate FWA (see Table 1) are added as a solution.

In order to simulate the size pressimetering size press application, the resulting solution is applied to one side of a base paper by means of a draw down rod, such that the wet pick-up is 28%.

After drying and conditioning, the ISO-Fluorescence (F_{ISO}) and degree of whiteness (W_{CIE}) of the resulting sheets are measured using a Datacolor Elrepho 3000 spectrophotometer.

The results of the measurements are summarized in the following Table 2 below.

TABLE 2

| Example Nr. | FWA Nr. | W_{CIE} | ISO-Fluorescence |
|---|---|---|---|
| Comparison | None | 122.2 | 13.4 |
| 1 | (105) | 142.3 | 19.2 |
| 2 | (110) | 134.1 | 16.0 |
| 3 | (104) | 146.0 | 20.2 |
| 4 | (114) | 137.2 | 17.0 |
| 5 | (113) | 136.6 | 16.8 |

Coating Application

An aqueous coating colour having a solids content of 28.5% was prepared consisting of 100 parts of silica (Gasil® M35), 30 parts, based on the weight of silica, of a polyvinyl alcohol (Mowiol® 4-98), based on the weight of silica, and 2 parts of poly-DADMAC, based on the weight of the silica, to which 0.4 parts, based on the weight of silica, of the appropriate FWA (see Table 1) are added as a solution.

The final coating colour is applied to a neutral sized base paper by means of a draw down rod, the paper dried and conditioned to result in a coat weight of 10 g/m² and the ISO-Fluorescence (F_{ISO}) and degree of whiteness (W_{CIE}) of the resulting sheets are measured using a Datacolor Elrepho 3000 spectrophotometer.

The results of the measurements are summarized in the following Table 3 below.

TABLE 3

| Example Nr. | FWA Nr. | W_{CIE} | ISO-Fluorescence |
|---|---|---|---|
| Comparison | None | 74.5 | 0.0 |
| 6 | (101) | 115.9 | 12.3 |
| 7 | (102) | 115.1 | 12.1 |
| 8 | (103) | 114.0 | 11.9 |
| 9 | (104) | 113.7 | 11.4 |
| 10 | (105) | 113.4 | 11.5 |
| 11 | (106) | 113.0 | 11.6 |
| 12 | (107) | 113.0 | 11.4 |
| 13 | (108) | 112.9 | 11.7 |
| 14 | (113) | 112.8 | 11.4 |
| 15 | (109) | 112.8 | 11.4 |
| 16 | (110) | 112.7 | 11.4 |
| 17 | (111) | 111.2 | 11.2 |
| 18 | Mixture of (105), | 115.0 | 12.2 |
| | (107) and (115) | | |
| 19 | Mixture of (105), | 113.4 | 11.7 |
| | (114) and (116) | | |
| 20 | Mixture of (103), | 110.1 | 10.5 |
| | (105) and (117) | | |

In addition to the obvious improvement in whiteness, the papers obtained show excellent printability and bleed fastness when used in ink jet printers.

1. A composition for optical brightening of substrates suitable for ink jet printing, comprising
a) a fluorescent whitening agent of the formula 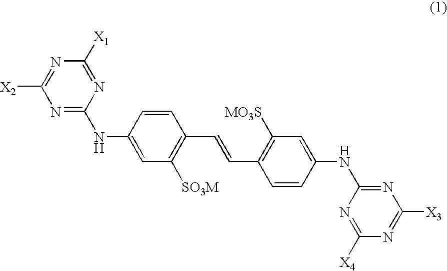
wherein
X₁, X₂, X₃ and X₄ each, independent of the other, represent —NR₁R₂ or —OR₃, wherein
R₁ and R₂ are, independently of each other,
hydrogen, cyano, a C₁-C₄alkyl group, which is unsubstituted or substituted by one or two of the following residues selected from the group consisting of C₁-C₄alkoxy, hydroxy, carboxyl or a salt thereof (—CO₂M), cyano, carbonamido, thiol, guanidine, substituted or unsubstituted phenyl, unsubstituted or C₁-C₄alkyl-substituted C₅-C₈cycloalkyl, halogen, a heterocycle and a sulphonic acid residue, and wherein the carbon chain of an alkyl group having two, three or four carbon atoms can be interrupted by oxygen,
or, alternatively, a C₅-C₇cycloalkyl group or
R₁ and R₂, together with the nitrogen atom linking them, complete a 5- or 6-membered heterocyclic ring;
R₃ represents C₁-C₄alkyl and
M represents H, Na, Li, K, Ca, Mg, ammonium, or ammonium that is mono-, di-, tri- or tetrasubstituted by C₁-C₄alkyl and/or C₂-C₄hydroxyalkyl or mixtures of fluorescent whitening agents of formula (1);
b) a cationic polymer;
c) water and, optionally,
d) at least one pigment and/or at least one further auxiliary.

2. A composition according to claim 1, in which, in the compound of formula (1),
X₁, X₂, X₃ and X₄ each independently, represent —NH₂, —NHCN, —NHC₁-C₄alkyl, —NHC₁-C₄cyanoalkyl, —N(C₁-C₄alkyl)₂, —NHC₂-C₄hydroxyalkyl, —N(C₂-C₄hydroxyalkyl)₂, —N(C₁-C₄alkyl)(C₂-C₄ hydroxyalkyl), —NH(C₂-C₄alkylene-C₁-C₄alkoxy), —N(C₂-C₄alkylene-C₁-C₄alkoxy)₂, —NHC₁-C₄alkylphenyl, tetrahydrofurfurylamino, morpholino, piperidino, pyrrolidino or cyclohexylamino or an, —NHC₁-C₄alkyl or, —N(C₁-C₄alkyl)₂ residue in which the alkyl groups are substituted by one or two carboxyl, carboxylate, carbonamido and/or hydroxyl groups, —OC₁-C₄alkyl or mixtures of compounds of formula (1).

3. A composition according to claim 1, in which, in the compound of formula (1),
X₁ and X₃ each, independently, represent —NH₂, —NHCH₂CH₂OH, —N(CH₂CH₂OH)₂ or a morpholino residue,
X₂ and X₄ each, independently, represent —NR₁R₂, wherein each
R₁ and R₂ independently represent hydrogen, cyano, a methyl or an ethyl group, which is unsubstituted or substituted by one residue selected from the group consisting of, hydroxy, methoxy or carboxy or a salt thereof (—CO₂M) or R₁ and R₂ together with the nitrogen atom complete a morpholino ring and
M represents hydrogen, sodium or ammonium or mixtures of the compounds of formula (1).

4. A composition according to claim 1, in which the cationic polymer, component b) is selected from the group consisting of:
cationic starch, quaternized or unquaternized polyvinyl amines, polyallyl amines and poly-ethylene imines, dicyandiamide condensates, polyamide-polyamine resins and polyamide-epichlorohydrin resins.

5. A composition according to claim 1, in which the filler pigment is an inorganic pigment.

6. A composition according to claim 1, which, as a further auxiliary, contains binders, agents for improving rheology and printability, fixing agents, wet-strength agents, antifoams and/or biocides.

7. A size press or film press liquor composition, useful for the optical brightening of substrates suitable for ink jet printing, comprising
a₁) 0.001 to 1% by weight of the fluorescent whitening agent of formula (1), according to claim 1, or mixtures thereof;
b₁) 1 to 20% by weight of one or more cationic polymer;
c₁) 0 to 10% by weight of pigment and/or further auxiliaries and
d₁) water to 100%.

8. A method for optical whitening of substrates suitable for ink jet printing, by applying to the substrate, in the size press or film press, a composition according to claim 7.

9. A coating colour, useful for the optical brightening of substrates suitable for ink jet printing, having a solids content comprising
a₂) 100 parts by weight of one or more inorganic pigment;
b₂) 0.01 to 1.2 parts by weight, based on the total weight of the pigment a₂), of the fluorescent whitening agent of formula (1), according to claim 1, or mixtures thereof;
c₂) 0.1 to 10 parts by weight, based on the total weight of the pigment a₂), of one or more cationic polymer and
d₂) 0 to 10 parts by weight, based on the total weight of the pigment a₂), of one or more auxiliary.

10. A method for optical whitening of substrates suitable for ink jet printing, by coating the substrate with an aqueous composition comprising 30 to 95% by weight of water and 70 to 5% by weight of the composition according to claim 9.

11. A substrate, which has been optically brightened according to the method of claim 8.

12. A substrate, which has been optically brightened according to the method of claim 10.
